(19) United States
(12) Patent Application Publication
(10) Pub. No.: US 2002/0191754 A1
(43) Pub. Date: Dec. 19, 2002

(54) Remote voice interactive computer systems

(76) Inventors: Zhenyu L. Liu, Pleasanton, CA (US); Lang S. Chen, Fremont, CA (US)

Correspondence Address: PATENT LAW OFFICES OF DAVID MILLERS, 6560 ASHFIELD COURT, SAN JOSE, CA, 95120, US

(21) Appl. No.: 09/871,487

(22) Filed: May 30, 2001

(51) Int. Cl. H04M 1/64

(52) U.S. Cl. 379/88.01

(57) ABSTRACT

A voice activation system for a home or office computer allows a user at a remote location to telephone the computer. A modem or other voice hardware for the computer provides a voice signal from the user to a voice activation system that analyzes the voice signal. When the voice activation system recognizes spoken commands in the voice signal, the voice activation system activates procedures according to the spoken command. One procedure in a system that uses the analog voice signal on a telephone line for voice and data hangs up on the user, contacts a dial-up service, downloads voice or e-mail messages from the dial up service, and the calls the user back. Another procedure accesses data such as a telephone number list stored in the computer and converts the data into a voice signal sent to the user at the remote location. With this system, the user can remotely access a computer and retrieve e-mail, voice mail, telephone numbers, and other information without special hardware such as a portable computer and can conduct the remote access without the need for hand touch.

### BACKGROUND

Computers are commonplace in homes and offices and are important tools for communications and management of information. In particular, people use computers to send and receive e-mail and to manage other communication such as voice mail and facsimiles. Computers also store of personal information such as calendars and telephone number lists.

Access to communications or information stored on a computer generally requires access to the computer containing the information. A person at home or the office has direct access to his or her computer and can directly retrieve e-mail or view calendar or telephone lists from the computer. When away from home or the office, remote access of the computer is possible, but remote access generally requires a portable computer or some other remote system for accessing the home or office computer. When a suitable remote system is unavailable, the communications and information from the home or office computer is unavailable.

A system is desired that does not require special hardware such as a portable computer but still permits access to a home or office computer.

### SUMMARY

In accordance with an aspect of the invention, a computer includes a voice activation system with an interface through a modem. A user remotely accessing the computer uses a telephone to call the computer, and the modem answers the call and passes a voice message from telephone system to the voice activation system. The voice activation system interprets the voice signal, recognizes spoken commands, and executes procedures identified by the spoken commands. The voice activation system may require the user to give a password before executing a procedure. Examples of such procedures include but are not limited to checking for e-mail or voice mail messages in an inbox in the computer or at a dial-up service, retrieving data such as a telephone number from a database, and reading e-mail or information via software that generates a voice message from the text. In one embodiment of the invention, the voice activation system after receiving a user's request to check e-mail or voice mail disconnects from the user, dials up a service provider, retrieves any e-mail or voice mail messages, and then calls the user back to provide any messages.

The system provides voice activation and can be used without hand operation of a keyboard or telephone touch pad. Further, the system is accessible from any telephone without additional remote hardware such as a portable computer.

### BRIEF DESCRIPTION OF THE DRAWINGS

FIGS. 1A and 1B are a block diagrams of systems in accordance with embodiments of the invention that provide remote voice activated communications with a computer directly connected to telephone lines.

FIG. 2A is a block diagram of a system in accordance with an embodiment of the invention that provides remote voice activated communications with an office having telephone and computer networks.

FIG. 2B is a block diagram of an embodiment of a hub suitable for the system of FIG. 2A.

FIG. 3 is a flow diagram of a remote voice-activated process in accordance with an embodiment of the present invention.

FIG. 4 is a flow diagram of a voice activated messaging process in accordance with an embodiment of the invention.

FIG. 5 is a block diagram of a voice activation portion of the system of FIG. 1A, 1B, or 2B.

Use of the same reference symbols in different figures indicates similar or identical items.

### DETAILED DESCRIPTION

In accordance with an aspect of the invention, a computer system includes a voice activation system that a remote telephone can access via a modem or other communication hardware in the computer system. The voice activation system analyzes a voice signal received from the remote user via a telephone system, identifies spoken commands in the voice signal, and executes procedures that the recognized spoken commands identify. Execution of the identified procedures can forward a voice mail message to the remote telephone or convert the text of an e-mail message or other requested information into a voice signal for transmission to the remote telephone. The user's spoken command can also direct the voice activation system to hang up, call and connect to an e-mail or voice mail service to download messages, and call the user back at a user-specified telephone number and during user-specified time frame to play any messages.

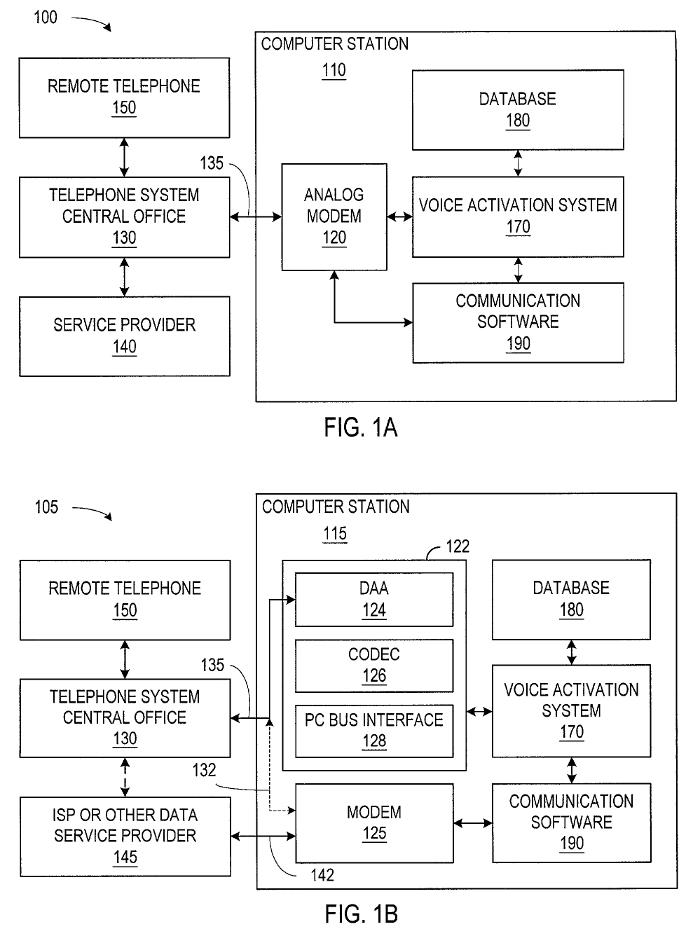

FIG. 1A illustrates a system 100 implementing remote voice activation in accordance with an embodiment of the present invention. System 100 includes a computer 110 with an analog modem 120 connected by a telephone line 135 to a telephone system central office 130. In an exemplary embodiment of the invention, computer station 110 is a personal computer at a fixed location such as a user's home or office. Computer station 110 provides a conventional operating environment including an operating system such MICROSOFT® WINDOWS, LINUX, or APPLE MACINTOSH OS for execution of applications such as database 180 and communication software 190. Computer station 110 also includes a voice activation system 170, which can be implemented in software or as a mixture of hardware and software as described further below.

Analog modem 120 is operable in a data mode or a voice mode and enters the respective modes in response to conventional AT commands. In the data mode, analog modem 120 implements a modem protocol such as a V.90 for data communications with a service provider 140 over telephone line 135. More particularly, analog modem 120 demodulates a received signal according to the modem protocol to produce data for use in computer 110 and coverts data generated in computer 110 into a transmitted analog signal in compliance with the modem protocol. In voice mode, modem 120 converts an analog voice signal received from a remote telephone 150 via central office 130 and telephone line 135 into a digital format (e.g., digital samples) used in computer 110. In voice mode, modem 120 also converts a digital signal generated in computer station 110 into an analog voice signal that modem 120 transmits via telephone line 135.

A system 105 in accordance with an alternative embodiment of the invention illustrated in FIG. 1B replaces analog modem 120 with a modem 125 and voice connection hardware 122. Modem 125 only performs data communication and can be an analog modem, a DSL modem, a cable modem, a wireless modem, or any other data communication hardware for connection to a service provider 145. Voice connection hardware 122 performs voice communications, which modem 125 may or may not be able to perform.

FIG. 1B shows two alternative connections 132 and 142 of modem 125 for communication with service provider 145. Generally, only one connection 132 or 142 is present in computer 115. For an embodiment of the invention where modem 125 is a DSL modem or analog modem, modem 125 uses connection 132 to telephone line 135 and communicates with service provider 145 via telephone central office 130. When modem 125 is a cable modem, a wireless modem, or a communication device that has a direct line or a telephone line other than telephone line 135, modem 125 uses connection 142 (e.g., a cable or wireless connection or a second telephone line) to communicate with service provider 145. Service provider 145 can thus be a dial up service or an always-on service that provides an Internet connection or e-mail access.

Voice connection hardware 122 is an additional communication device that connects to telephone line 135 and a PC bus of computer 115. Voice connection hardware 122 includes a DAA circuit 124, a codec 126, and a PC bus interface 128. DAA circuit 124 provides a telephone line interface capable of high voltage isolation for the safety requirement and of answering and initiating telephone calls through central office 130. Codec 126 performs analog-to-digital conversion of a received voice signal from DAA and digital-to-analog conversion of data generated in computer 115 to generate a transmitted voice signal. Computer bus interface 128 performs data transfer to and from a computer bus such as a PCI bus or a USB in computer 115.

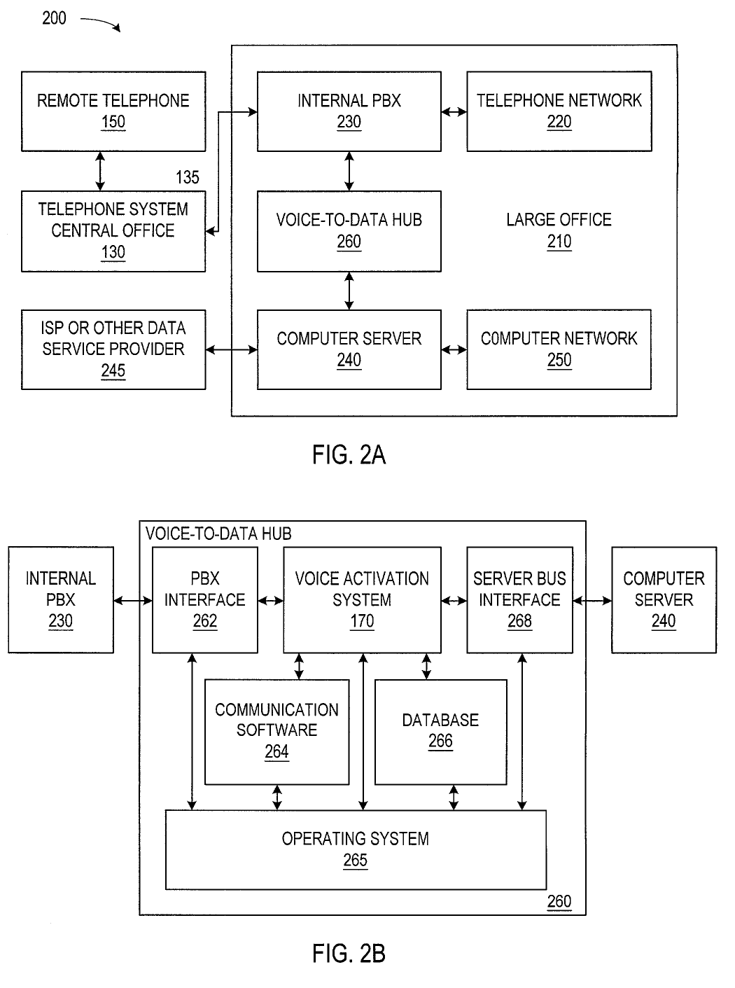

Yet another embodiment of the invention can be implemented in an office environment having a computer network and a telephone network instead of having a modem in each computer. FIG. 2A illustrates a system 200 for a large office environment 210 that includes a telephone network 220 connected to public telephone line 135 through an internal PBX 230 and a computer network 250 having a server 240 that controls external access to a data service provider 245. Server 240 can connect to data service provider 245 through a high-speed line such as a T1 line that is independent of internal PBX 230. In accordance with an aspect of the invention, a voice-to-data hub 260 provides an interface between internal PBX 230 and computer server 240 and implements voice activation of computer functions in office 210.

Generally, internal PBX 230 provides telephone services such as organizing telephone network 220 incoming/outgoing calls and each telephone extension's voice mail. In one embodiment of the invention, internal PBX 230 provides voice mail functions, and a user can initiate voice access of data through voice-to-data hub 260 when the user accesses the voice mail functions of internal PBX 230. Alternatively, voice-to-data hub 260 can be assigned one or more lines or extensions that allow remote telephone 150 to call and access voice-to-data hub 260. A user telephoning voice-to-data hub 260 can then access voice mail functions and data functions by voice activation implemented in voice-to-data hub 260.

FIG. 2B is a block diagram of a voice-to-data hub 260 for use in office environment 210. In this embodiment, voice-to-data hub 260 is a computer having the necessary hardware and software to communicate with both internal PBX 230 and network server 240 and to execute voice activation system 170. In the illustrated embodiment, voice-to-data hub 260 includes a PBX interface 262, communication software 264, a database 266, and a server bus interface 268, which operate under control of an operating system 265.

PBX interface 262 includes hardware and software for receiving and initiating telephone calls through internal PBX 230 and for transmission of digitized voice data to and from voice activation system 170. In generally, a user at a remote telephone 150 (FIG. 2A) can access voice activation system 170 by dialing the telephone number and/or extension that internal PBX 230 assigned to voice-to-data hub 260 and can give spoken commands to voice activation system 170. Voice activation system 170 through PBX interface 262 can return telephone calls to the user at remote telephone 150.

On the data side of voice-to-data hub 260, voice activation system 170 uses server bus interface 268 to access computer server 240 and to access computer network 250 through server 240. Accordingly, voice activation system 170 through communication software 264 can access service provider 245 through server 240. Voice activation system 170 can also access information from server 240 or any accessible computer on network 250 via server bus interface 268.

Voice activation system 170 has direct access to data that is stored in database 266 within voice-to-data hub 260. Database 266 can contain data such as telephone lists, calendar or appointment information for all network users inside the office, or any type of office-wide or user-specific information.

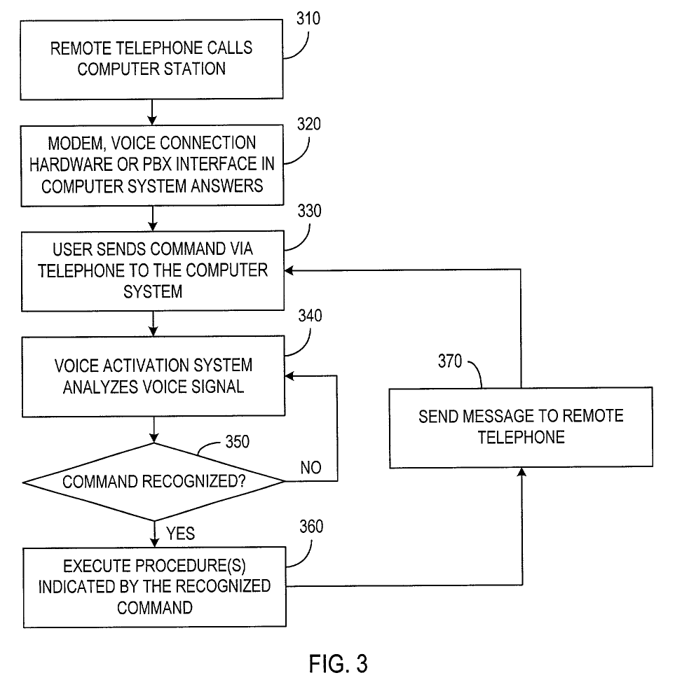

FIG. 3 is a flow diagram of a process 300 illustrating remote access of system 100 of FIG. 1A. Remote access of systems 105 and 200 of FIGS. 1B and 2A is similar and described further below. To enable remote access of system 100, modem 120 is set to answer in-coming telephone calls and to operate in voice mode. Computer station 110 can also be set to periodically check service provider 140 to download any messages to an inbox in computer station 110. In step 310, a user of remote telephone 310 calls computer station 110. Modem 120 answers the telephone call in step 320 and begins receiving a voice signal. Voice activation system 170 can send to remote telephone 150 an audible queue or message indicating that computer station 110 is ready to receive spoken commands.

The access process can alternatively begin with computer station 110 calling the user at remote telephone 150. More particularly, computer station 110 can call the user at a user-specified telephone number if user-specified conditions are met. The user can store the telephone number, for example, from the remote side through voice command or key in during a prior remote access of computer station 110. Computer station 110 could then call remote telephone 150 when computer station downloads or detects a new e-mail or voice mail message for the user, at specific intervals or specific times, or according to any other user-selected conditions.

When the telephone connection between remote telephone 150 and computer station 110 is established, the user in step 330 speaks to computer station 110 via telephone central office 130 and modem 120. Modem 120, which is in voice mode, forwards samples of the voice signal from remote telephone 150 to voice activation system 170 for analysis.

In step 340, voice activation system 170 analyzes the voice signal in an attempt recognize spoken commands from remote telephone 150. Voice recognition methods and systems are generally known in the art, and any such system can be used to identify spoken commands.

In an exemplary embodiment, voice activation system 170 includes a library of command data that voice activation system 170 compares to the incoming voice signal. The user can use a training process for voice activation system 170 to create the library of command data for a speech dependent application. The library is thus customized according the user's selection of words and the users speech patterns. In the library, the user can create a password that voice activation system 170 must recognize before executing any procedures associated with the spoken commands. In the case of speech non-dependent application, the commands in the library are predefined and cannot be changed by user, and the training process may or may not required for a speech non-dependent application.

Analysis 340 of the voice signal continues until voice activation system 170 recognizes a command in step 350 or the connection to remote telephone 150 is broken. After recognizing a command, voice activation system 170 in step 360 executes a procedure associated with the command and the context of the command. Execution of the procedure typically includes a step 370 of sending a voice message back to remote telephone 150 to either acknowledge the command or return information that the command requested.

In accordance with a further aspect of the invention, examples of executed procedures 360 include use of e-mail or voice mail functions and general access to data available from computer station 110. E-mail functions include real time checking of e-mail, accessing detailed information about received e-mail, listening to e-mail messages through text-to-speech technology, and sending or replying to e-mail. Voice mail functions include real time checking of incoming voice-mail and automated callback to remote telephone 150 that enables the user to promptly receive and respond to voice-mail. General data accesses include access to a contact list or calendar for retrieval e-mail addresses, telephone numbers, street addresses, and appointment information through text-to-speech conversion. These functions can all be provided through voice activation with no hand touch required. Accordingly, a user can activate the functions while at a remote or mobile location.

A remote access process for system 105 of FIG. 1B is the same as the above-described process 300 except that voice connection hardware 122 conducts the telephone communications with remote telephone 150. In system 200, internal PBX 230 and voice-to-data hub 260, particularly PBX interface 262, implement the communications between remote telephone 150 and voice activation system 170. However, the specifics of executing procedures 360 in response to the spoken commands depend on the system specifics such as the connection mechanism to a service provider.

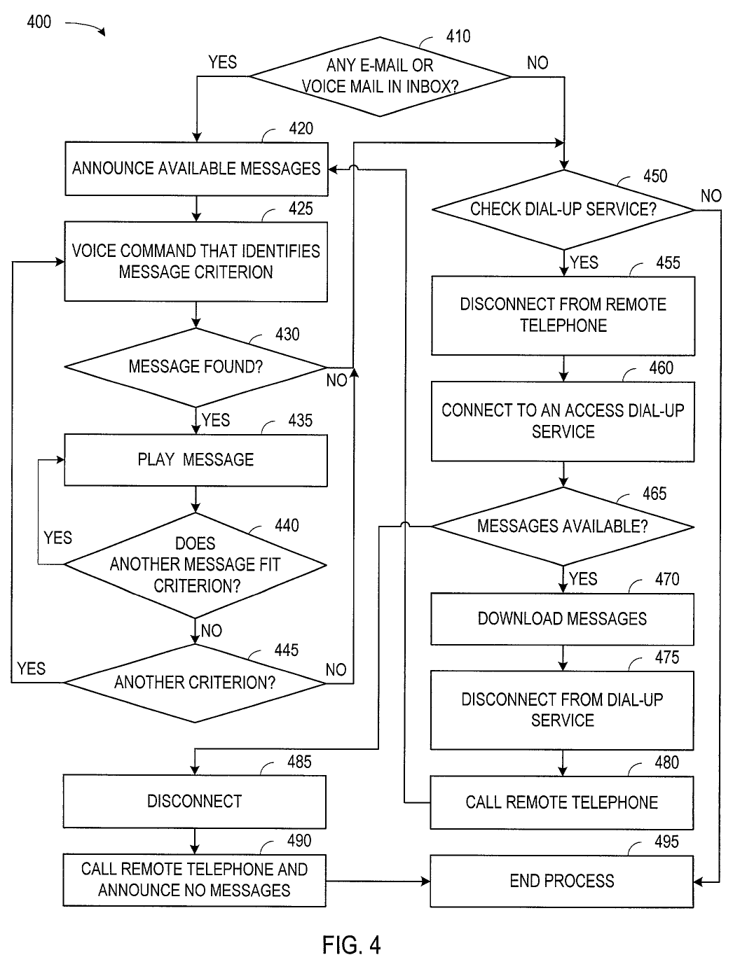

FIG. 4 is a flow diagram a process 400 for accessing e-mail in system 100 of FIG. 1A, which uses one telephone line 135 and a dial-up service provider 140. In system 100, voice activation system 170 executes process 400 in response to recognizing a command to access e-mail or a command to access voice mail. (See steps 350 and 360 of FIG. 3.) As an alternative to accessing e-mail or voice mail messages as in process 400, computer station 110 can execute any desired procedure or program in response to corresponding spoken commands.

In step 410 of process 400, voice activation system 170 checks an inbox in computer station 110 for available e-mail or voice mail. If the inbox contains e-mail or voice mail messages, voice activation system 170 informs the user in step 420 that messages are available and waits for further commands 425 from the user. The user's spoken commands 425 then indicate which if any of available messages are of interest. In particular, the user can request that voice activation system 170 list the available e-mail or voice mail messages. In response, voice activation system 170 converts identifying information such as sender and time sent for each message into a voice signal sent to remote telephone 150. The user then can request a particular message from the list using, for example, an identifying number, e.g., message “one”. Alternatively, the remote user can indicate a criterion such as all messages, all new or unread messages, or only messages from a particular sender. Generally, identification of a particular sender will require training voice activation system 170 to recognize that sender's name.

In step 430, voice activation system 170 determines whether any available messages match the user's criterion. If there is a match, voice activation system 170 in a step 435 plays a voice mail message or converts text of an e-mail message into a voice signal sent to remote telephone 150. Voice activation system 170 in step 440 then checks for another available message fitting the user's criterion, and plays the next message fitting the criterion. If none of the available messages fit the user's criterion, voice activation system 170 in step 445 prompts the user to request another criterion.

If the user is not interested in any of the available messages or there are no messages in the inbox, voice activation system 170 transfers from step 445 or 410 to step 450, which determines whether the user would like to check for messages from service provider 140. More particularly, voice activation system 170 prompts the user and waits for a voice command indicating whether or not to check service 140. Process 400 ends in step 495 if the user's indicates the user does not want to check service 140 now.

Process 400 is for system 100 of FIG. 1A in which service provider 140 is a dial-up service that computer station 110 cannot access while communicating with remote telephone 150. However, if modem 120 is a DSL mode and capable of accessing service provider 140 without disconnecting the connection to remote telephone 150, voice activation system 170 does not need to disconnect from remote telephone 150 and can check a service 140 and report whether new e-mail messages are available. In system 115 of FIG. 1B, for example, modem 125 can access data service 145 while voice connection hardware 122 maintains the connection to remote telephone 150. Similarly, system 200 of FIG. 2 has separate lines for data and voice communications.

To check dial-up service 140 in system 100 of FIG. 1A, voice activation system 170 instructs modem 120 to hang up in a step 455 (breaking the connection to remote telephone 150) and call dial-up service 140 in step 460. Hanging up frees telephone line 135 and allows connection to dial-up service 140 without having a separate line for accessing service provider 140. Voice activation system 170 automatically conducts a log-on procedure for dial-up service 140 and then checks for available e-mail or voice mail from dial-up service 140. In step 465, voice activation system 170 checks for available messages from dial-up service 140.

If dial-up service 140 does not have messages for the user, computer station 110 in a step 485 hangs up or otherwise disconnects from dial up service 140 and in step 490 calls remote telephone 150 to inform the user that no new messages are available. The call back cane either be immediate or at a user-selected time. Process 400 can then end in step 495.

If dial-up service 140 has one or more messages for the user, computer station 110 in step 470 downloads the messages. More particularly, voice mail messages can be digitally stored in memory of computer station 110, while e-mail messages are store in a text format. After downloading messages, computer station 110 in a step 475 disconnects from the dial-up service and then in a step 480 calls the user at remote telephone 150. More particularly, computer station 110 calls the user when the e-mail or voice mail message meets the user's predefined conditions, such as being from a particular e-mail sender or voice mail sender with matched caller ID number for which the user is waiting. Once the user at remote telephone 150 is authenticated as the intended recipient (e.g., the user voices a recognized password), voice activation system 170 announces the available messages in step 420 and the process of identifying and playing messages proceeds from step 420 as described above.

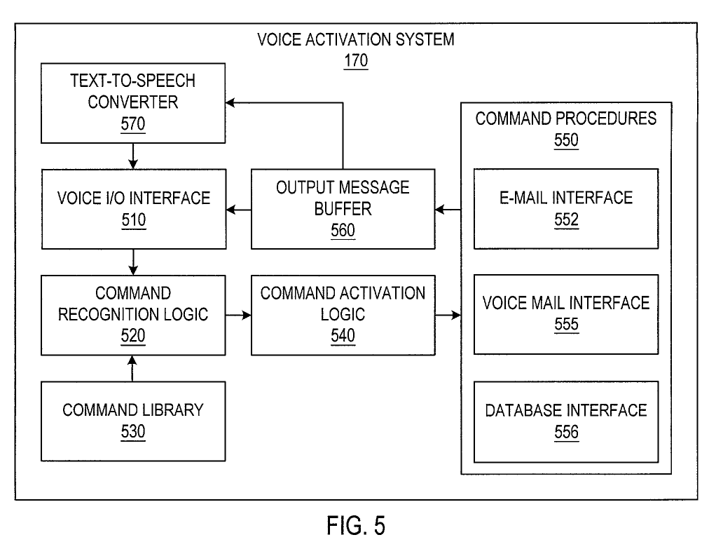

FIG. 5 is a block diagram of an embodiment of voice activation system 170. In the illustrated embodiment, voice activation system 170 includes voice input/output (I/O) interface 510, command recognition logic 520, a command library 530, command activation logic 540, command procedures 550, an output message buffer 560, and a text-to-speech converter 570. Generally, voice activation system 170 can be implemented entirely in software or as a mixture of software and hardware.

In system 100 or 105, voice interface 510 communicates with modem 120 or voice connection hardware 122 via the operating system of the host computer 110 or 115. In system 200, voice I/O interface 510 communicates with PBX interface 262.

Command recognition logic 520 analyzes the received voice signal and searches for spoken commands. Command recognition logic 520 can be implemented in hardware or software that compares portions of the received voice signal to command data from a command library 530. The command library includes data associated with a set of commands. In a speech dependent application, the command data is constructed as a result of a training process that develops the command data according to the speech patterns and word selections of a user. In a speech non-dependent application, the training process may or may not required, and the words in command library 530 are predefined and cannot be changed by user.

An exemplary embodiment of command recognition logic 520, which is described here as merely one example of a suitable process, is implemented in software that begins by filtering a voice signal into multiple (e.g., 16) separate frequency bands. For each frequency band i, recognition logic 520 determines the average of the peak amplitude Pi(t) over a short time period, typically about 20 ms. The resulting average peaks Pi(t) over the range of frequency band index i provide a set of peak values (e.g., sixteen 8-bit peak values) that characterize a portion of the voice signal. An average T(t) of the frequency band average peak values Pi(t) is determined as a reference for that time period.

A bit set referred to herein as a line is generated from the set of average peak values Pi(t). Each bit in the line corresponds to a different average peak value Pi(t), and a bit is set to “1” if the associated average peak value Pi(t) is greater than the total frequency band average peak value T(t) and greater than a minimum energy threshold that depends on noise levels in the system. Otherwise, the bit is set to “0”.

To represent a spoken word, a bit array is constructed from a series of m lines, where m depends on the length of the spoken word. Start and end of the word can be identified as a period between times when the average peak values all or almost all fall below the background noise level. A bit array created as indicated above uses a relatively small amount of data to represent the tonality of a spoken word.

Command recognition logic 520 compares lines of a bit array A representing a word extracted from a voice signal to lines of a bit array B associated with a command to determine whether array A matches array B. To determine whether two lines A1 and B1 match, a bit-by-bit comparison uses a bit position weighted K factor. In this comparison, a bit in line A1 that matches (i.e., is equal to) a bit at the same position in line B1 adds nothing to a K factor total. A bit in line A1 that does not match a bit at the same position in line B1 but does match a bit in an adjacent position in line B1 adds a factor K1 to the K factor total. A bit in line A1 that does not match any of the bits in the same or adjacent positions in line B1 adds a larger factor K2 to the K factor total. A large K factor total for a pair of lines indicates that the lines don't match. A K factor total that is zero or small indicates matching lines.

When comparing lines of array A to lines of array B, command recognition logic 520 must identify which lines in array B correspond to the lines in array A. Generally, if words are spoken at different speeds, bit arrays A and B representing the same spoken word may have a different number of lines. When comparing two arrays, the exemplary embodiment of command recognition logic 520 always chooses a line from the smaller array and finds the best-matched line in the larger array and alternates between a top-down identification of corresponding lines and bottom-up identification of corresponding lines. If, for example, array A contains m lines A1 to Am, and array B contains n lines B1 to Bn and n is greater than m, command recognition logic 520 performs initial comparisons such as illustrated in Table 1.

TABLE 1

| Array A | | Array B |
|---|---|---|
| A1 | compared to | B1 |
| Am | compared to | Bn |
| A2 | compared to | B2 |
| Am-1 | compared to | Bn-1 |

In particular, command recognition logic 520 starts by comparing top lines A1 and B1 to each other and bottom lines Am and Bn to each other. The total K factors for these two comparisons are added to begin an accumulation of K factors. Then command recognition logic 520 starts to perform top-down and bottom-up matching processes to accumulate a total K factor for the comparison of the arrays. When performing the top-down process, command recognition logic 520 chooses a top line from the shorter array of remaining lines and finds the best-matched line from the longer array of remaining lines. When the bottom-up process, command recognition logic 520 chooses bottom line from the shorter array of remaining lines to find the best-matched line from the longer array of remaining lines. For example, if after each comparison, the remaining lines from array A always form a shorter array than the remaining lines of array B for this example, then the process performs line comparisons for A1, Am, A2, Am−1, A3 etc.

Each downward moving comparison process compares the next line down from the top in shorter array (initially line A2) to a series of lines in the longer array. The series of lines in the longer array begins with a downward pointer (initially pointing to line A1) and moves downward if a comparison with a line in the longer array proves to be the better match (e.g., a smaller total K factor) than the comparison for the line below in the longer array. Logic 520 sets the downward pointer to point to the line in the longer array providing the best match, and adds the total K factor for the best match comparison to the accumulation of K factors. The downward pointer indicates a boundary of the remaining lines in the array and is used in a subsequent identification of the shorter and longer array or remaining lines for comparisons.

The upward moving comparison process similarly compares the next line up from the bottom in shorter array to a series of lines in the longer array. This series of lines in longer array begins with an upward pointer and moves up until a line comparison proves to be a better match than the comparison with the line above. Logic 520 changes the upward pointer to point to the line in the longer array proving the best match, and adds the total K factor for the best match comparison to the accumulation of K factors. Again, the change in the pointer is used for subsequent determinations of which array of remaining lines is longer or shorter.

After identifying corresponding lines in arrays A and B and accumulating the K factors for all compared lines in the process, command recognition logic 520 uses the accumulated K factors to determine whether arrays A and B match. Generally, whether arrays match depends on the accumulated K factors and the number of compared lines in the process.

Command recognition logic 520 compares array A to each array in command library 530 until command library 530 is exhausted or the best matching command is found (the best matching within the command library must have an accumulated total K factor less than predefined threshold). Command recognition logic 520 upon recognizing a spoken command in the received voice signal forwards data to command activation logic 540 to indicate which spoken command voice activation system 170 received.

From the context and order of the spoken command or commands, command activation logic 540 determines which command procedures 550 to activate. As examples of command procedures, FIG. 5 shows an e-mail interface 552, a voice mail interface 554, and a database interface 556. E-mail interface 552 accesses system resources such as a browser or other communication software to receive or send e-mail as described above. Voice mail interface 554 similarly uses system resources to retrieve voice mail, and database interface accesses data in the computer system. More generally, command procedures 550 can include any procedures that the computer system (e.g., computer system 100, 105, or 200) is capable of executing.

The execution of any of command procedures 550 typically produces a message for transmission to the remote user. The message can be formatted as a voice signal (e.g., audio samples) or as text. Text-to-speech converter 570 converts a text message to a voice signal that for transmission via voice I/O interface 510.

Although the invention has been described with reference to particular embodiments, the description is only an example of the invention's application and should not be taken as a limitation. In particular, although the above description describes exemplary systems and command recognition logic, alternative embodiments can be implemented computer systems having other configurations and/or other command recognition processes. Various other adaptations and combinations of features of the embodiments disclosed are also within the scope of the invention as defined by the following claims.

We claim:

1. A process executed on a computer comprising:
receiving via a telephone system a voice signal from a user;
analyzing the voice signal in an attempt to recognize spoken commands in the voice signal; and
executing a procedure associated with a spoken command recognized in the voice signal.

2. The process of claim 1, wherein receiving the voice signal comprises receiving the voice signal via a modem that connects the computer to the telephone system.

3. The process of claim 1, wherein analyzing the voice signal comprises comparing portions of the voice signal to command data from a library of spoken commands stored in the computer.

4. The process of claim 1, wherein the library of spoken commands comprises command data derived from words spoken by the user.

5. The process of claim 4, wherein the library of spoken commands comprises command data corresponding to a password spoken by the user.

6. The process of claim 1, wherein executing the procedure comprises:
breaking connection on the telephone system that provides the voice signal from a user;
contacting a dial-up service via the telephone system;
checking for messages available from the dial-up service;
breaking connection to the dial-up service;
contacting the user via the telephone system; and
informing the user via the telephone system of message status.

7. The process of claim 6, wherein
checking for messages comprises storing messages from the dial-up service in memory of the computer; and
informing the user of message status comprises transmitting an audible version of the message to the user.

8. The process of claim 7, wherein the message is a voice mail message and transmitting the audible version comprises transmitting the message via the telephone system to the user.

9. The process of claim 7, wherein the message comprises text message and transmitting the audible version comprises converting the text to a second voice signal and transmitting the second voice signal via the telephone system to the user.

10. The process of claim 1, wherein executing the procedure comprises:
accessing data stored in the computer;
converting the data into a second voice signal; and
transmitting the second voice signal via the telephone network to the user.

11. The process of claim 10, wherein the data represents a telephone number from a database stored in the computer.

12. The process of claim 1, wherein executing the procedure comprises:
contacting a service via a separate channel while maintaining connection on the telephone system;
checking for messages available from the service; and
informing the user via the telephone system of message status.

13. The process of claim 12, wherein the separate channel is a channel on the telephone system for data transmission.

14. The process of claim 13, wherein the channel comprises a separate line that is independent of the telephone system.

15. A system comprising:
a telephone interface between a computer and a telephone system, the telephone interface being capable of receiving and sending voice signals to and from the computer;
a voice activation system operable to receive and analyze a voice signal from the telephone interface; and
a plurality of procedures that are executable by the computer, wherein during analysis of the voice signal, the voice activation system activates execution of selected ones of the procedures in response to recognizing spoken commands in the voice signal.

16. The system of claim 15, wherein the telephone interface comprises a modem coupled to the computer.

17. The system of claim 15, wherein the telephone interface comprises voice connection hardware capable of answering and initiating telephone calls.

18. The system of claim 15, wherein the telephone interface communicates with an internal PBX system.

19. The system of claim 15, further comprising a data interface for connection to a data services provider.

20. The system of claim 19, wherein the data interface comprises a cable modem.

21. The system of claim 19, wherein the data interface comprises a server connected to the data service via a direct line.

22. The system of claim 19, wherein the data interface comprises a DSL modem.

23. The system of claim 22, wherein the DSL modem connects to the telephone system through a line also used by the telephone interface.
